(19) United States
(12) Patent Application Publication
(10) Pub. No.: US 2014/0168020 A1
(43) Pub. Date: Jun. 19, 2014

(54) ANTENNA COMBINED WITH LIGHTING DEVICE

(71) Applicants: Marin Stoytchev, Chandler, AZ (US); Cliff Connors, Tempe, AZ (US); Gary Wannagot, Gilbert, AZ (US); Samuel Zaila, Phoenix, AZ (US); Ricky Chair, Phoenix, AZ (US); Randell Cozzolino, Phoenix, AZ (US)

(72) Inventors: Marin Stoytchev, Chandler, AZ (US); Cliff Connors, Tempe, AZ (US); Gary Wannagot, Gilbert, AZ (US); Samuel Zaila, Phoenix, AZ (US); Ricky Chair, Phoenix, AZ (US); Randell Cozzolino, Phoenix, AZ (US)

(73) Assignee: GALTRONICS CORPORATION LTD., Tiberias (IL)

(21) Appl. No.: 14/115,213

(22) PCT Filed: May 3, 2012
(86) PCT No.: PCT/IL2012/000180

§ 371 Date: Dec. 17, 2013

Related U.S. Application Data
(60) Provisional application No. 61/481,791, filed on May 3, 2011.

(51) Int. Cl. H01Q 1/22; F21V 23/00

(52) U.S. Cl. CPC H01Q 1/22; F21V 23/00
USPC 343/721

(57) ABSTRACT

A lighting device including at least one light source, a housing located adjacent to the at least one light source, the housing defining a longitudinal axis and being intersected by a lateral axis and an antenna at least partially enclosed by the housing and located proximal to the at least one light source, the antenna being operative to radiate energy, more than half of the energy being radiated in a direction within a hemisphere symmetric about the longitudinal axis and having an equatorial plane in which the lateral axis extends.

### REFERENCE TO RELATED APPLICATIONS

Reference is hereby made to U.S. Provisional Patent Application 61/481,791, entitled LOOP ANTENNA FOR WIRELESSLY CONTROLLED LIGHTING DEVICE, filed May 3, 2011, the disclosure of which is hereby incorporated by reference and priority of which is hereby claimed pursuant to 37 CFR 1.78(a)(4) and (5)(i).

### FIELD OF THE INVENTION

The present invention relates generally to lighting devices and more particularly to lighting devices having antennas incorporated therein.

### BACKGROUND OF THE INVENTION

The following U.S. Patent documents are believed to represent the current state of the art:

U.S. Pat. Nos. 5,424,859; 6,759,966; 7,714,699 and 8,033,686.

### SUMMARY OF THE INVENTION

The present invention seeks to provide a lighting device including a compact, efficient antenna particularly suited for incorporation therein.

There is thus provided in accordance with a preferred embodiment of the present invention a lighting device, including at least one light source, a housing located adjacent to the at least one light source, the housing defining a longitudinal axis and being intersected by a lateral axis and an antenna at least partially enclosed by the housing and located proximal to the at least one light source, the antenna being operative to radiate energy, more than half of the energy being radiated in a direction within a hemisphere symmetric about the longitudinal axis and having an equatorial plane in which the lateral axis extends.

Preferably, the at least one light source includes at least one light emitting diode.

Additionally or alternatively, the at least one light source includes at least one compact fluorescent lamp.

Preferably, the antenna is fully enclosed by the housing.

Preferably, the antenna is located with respect to the at least one light source so as to have a negligible effect on the light emissive properties of the at least one light source.

In accordance with a preferred embodiment of the present invention, the housing includes a socket adapted for connection to a power supply.

Preferably, the hemisphere is directed away from the socket.

In accordance with a further preferred embodiment of the present invention, the housing includes a heat sink.

Preferably, the antenna is supported by the heat sink.

In accordance with another preferred embodiment of the present invention, the antenna is supported by a holder of the at least one light source.

In accordance with yet another preferred embodiment of the present invention, the antenna is supported by a collimator.

In accordance with yet a further preferred embodiment of the present invention, the antenna is supported by a printed circuit board.

In accordance with a still further preferred embodiment of the present invention, the antenna is supported by a dedicated non-conductive carrier.

Preferably, the antenna is planar. Alternatively, the antenna has three-dimensional geometry.

Preferably, the antenna includes a single-feed antenna.

Preferably, the antenna is adapted for at least one of wireless control and wireless monitoring of the lighting device.

Preferably, the antenna is adapted for wireless communication with a control module.

Preferable, the antenna is adapted for wireless communication with wireless devices in a wireless network.

### BRIEF DESCRIPTION OF THE DRAWINGS

The present invention will be understood and appreciated more fully from the following detailed description, taken in conjunction with the drawings in which:

FIGS. 1A and 1B are simplified respective exploded and assembled view illustrations of a lighting device constructed and operative in accordance with a preferred embodiment of the present invention;

FIGS. 2A and 2B are simplified respective exploded and assembled view illustrations of a lighting device constructed and operative in accordance with another preferred embodiment of the present invention;

FIGS. 3A and 3B are simplified respective exploded and assembled view illustrations of a lighting device constructed and operative in accordance with yet another preferred embodiment of the present invention;

FIGS. 4A and 4B are simplified respective exploded and assembled view illustrations of a lighting device constructed and operative in accordance with a further preferred embodiment of the present invention;

FIGS. 5A, 5B and 5C are simplified respective perspective and top exploded and assembled view illustrations of a lighting device constructed and operative in accordance with yet a further preferred embodiment of the present invention;

FIGS. 6A and 6B are simplified respective exploded and assembled view illustrations of a lighting device constructed and operative in accordance with another preferred embodiment of the present invention;

FIGS. 7A and 7B are simplified respective exploded and assembled view illustrations of a lighting device constructed and operative in accordance with still another preferred embodiment of the present invention;

FIGS. 8A and 8B are simplified respective exploded and assembled view illustrations of a lighting device constructed and operative in accordance with a still further preferred embodiment of the present invention;

FIGS. 9A and 9B are simplified respective exploded and assembled view illustrations of a lighting device constructed and operative in accordance with another preferred embodiment of the present invention;

FIGS. 10A and 10B are simplified respective exploded and assembled view illustrations of a lighting device constructed and operative in accordance with yet another preferred embodiment of the present invention;

FIGS. 11A and 11B are simplified respective exploded and assembled view illustrations of a lighting device constructed and operative in accordance with a further preferred embodiment of the present invention;

FIGS. 12A and 12B are simplified respective exploded and assembled view illustrations of a lighting device constructed and operative in accordance with yet a further preferred embodiment of the present invention;

FIGS. 13A and 13B are simplified respective exploded and assembled view illustrations of a lighting device constructed and operative in accordance with a still further preferred embodiment of the present invention; and

FIGS. 14A and 14B are simplified respective exploded and assembled view illustrations of a lighting device constructed and operative in accordance with another preferred embodiment of the present invention.

### DETAILED DESCRIPTION OF PREFERRED EMBODIMENTS

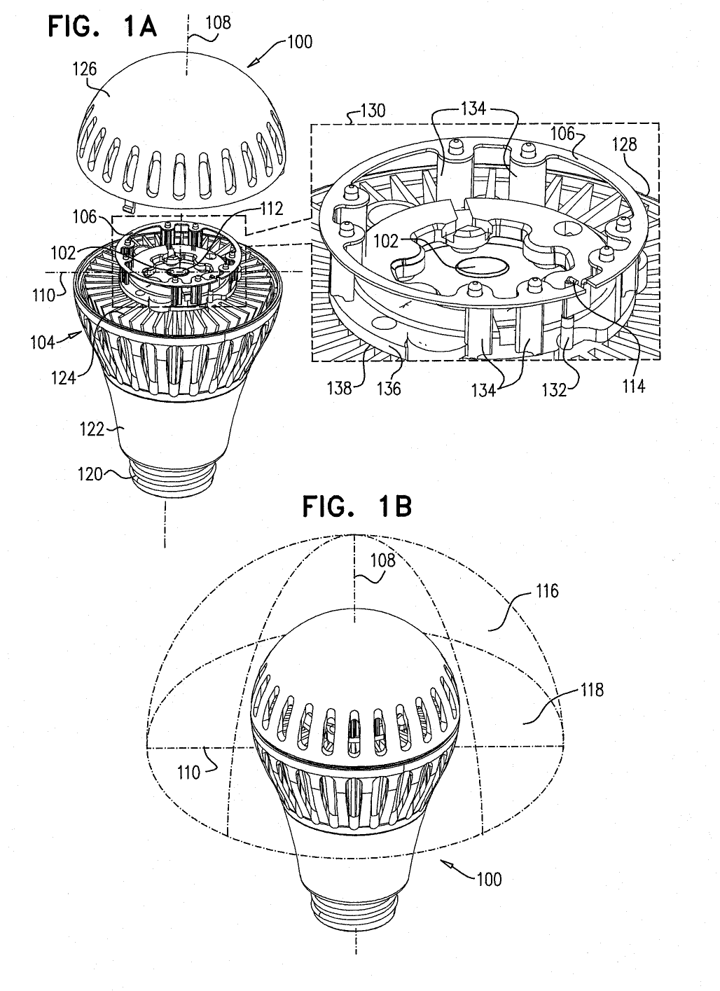

Reference is now made to FIGS. 1A and 1B, which are simplified respective exploded and assembled view illustrations of a lighting device constructed and operative in accordance with a preferred embodiment of the present invention.

As seen in FIGS. 1A and 1B, there is provided a lighting device 100, including at least one light source 102, here embodied, by way of example, as a light emitting diode (LED). It is appreciated that the inclusion of a single LED 102 in lighting device 100 is exemplary only and that lighting device 100 may alternatively include multiple light sources. It is further appreciated that lighting device 100 may additionally or alternatively include single or multiple light sources other than LEDs, such as compact fluorescent lamps (CFLs), as will be exemplified henceforth.

Lighting device 100 further includes a housing 104 and an antenna 106 located proximal to LED 102 and at least partially, and here, by way of example, fully enclosed by housing 104, as seen most clearly in FIG. 1B. Housing 104 defines a longitudinal axis, indicated by a first dashed line 108, and is intersected by a lateral axis, indicated by a second dashed line 110. The longitudinal axis 108 of housing 104 is preferably perpendicular to the lateral axis 110 of housing 104. Longitudinal axis 108 preferably intersects with lateral axis 110 at a central point 112 of housing 104, at which point 112 LED 102 is preferably located.

Antenna 106 is preferably operative to transmit and receive radio-frequency (RF) signals. During transmit, antenna 106 preferably receives an input signal at a feed point 114 and emits RF radiation at a predetermined energy and frequency range. Antenna 106 thus may be employed for wireless control and/or monitoring of the operation of lighting device 100 by way of wireless RF communication with a control module (not shown). Antenna 106 may alternatively be employed for communicating with other wireless devices as part of a wireless network. The frequency range of radiation of antenna 106 is dependent on its electrical length, which electrical length may be chosen so as to allow antenna 106 to radiate at frequencies appropriate for communication with wireless communication protocols, such as WiFi, Zigbee, 6LoWPAN and IEEE standard 802.15.4.

It is a particular feature of a preferred embodiment of the present invention that more than half of the energy radiated by antenna 106 is radiated in a direction within a hemisphere 116, which hemisphere 116 is symmetric about the longitudinal axis 108 and has an equatorial plane 118 in which the lateral axis 110 extends. As a result of its predominantly hemispherical radiation pattern, antenna 106 is particularly well suited for integration within overhead-mounted lighting devices, whereby a maximum wireless communication range may be achieved.

It is understood that the dimensions of hemisphere 116 indicated in FIG. 1B are shown for illustrative purposes only, in order to exemplify the three-dimensional geometrical scope of hemisphere 116. In actuality, hemisphere 116 may extend beyond those limits indicated in FIG. 1B, to infinity.

Antenna 106 is preferably embodied as a ring-shaped radiating element, preferably encircling LED 102. It is a further particular feature of a preferred embodiment of the present invention that, despite its proximity to LED 102, antenna 106 preferably has a negligible effect on the light emissive properties of LED 102. Particularly preferably, antenna 106 is adapted so as to have minimal effects on the luminous intensity and uniformity of emission of light by lighting device 100, due to the ring-shaped structure of antenna 106 which offers minimal obstruction to light emission from LED 102.

As seen most clearly in FIG. 1A, housing 104 preferably includes a socket 120, by way of which socket 120 lighting device 100 is preferably connected to a power supply (not shown). It is appreciated from consideration of FIGS. 1A and 1B that hemisphere 116 is preferably directed away from socket 120 such that more than half of the energy emitted by antenna 106 is radiated in a direction away from the power supply of lighting device 100. It is further appreciated that the particular configuration of socket 120 illustrated in FIGS. 1A and 1B is exemplary only and that lighting device 100 may alternatively be connected to a power supply by any other appropriate connection means known in the art.

A base 122 preferably emerges from socket 120, which base 122 preferably abuts a metallic heat sink 124. Heat sink 124 is preferably provided in lighting device 100 so as to conduct heat away from LED 102 and thereby prevent overheating of the device 100. Housing 104 further preferably includes a bulb cover 126 preferably affixed to an upper rim 128 of heat sink 124, through which bulb cover 126 light emitted by LED 102 is transmitted.

It is appreciated that the particular elements and configuration of housing 104 are exemplary only and that housing 104 may optionally include additional elements, such as a light collimator and/or light reflector. Conversely, housing 104 may alternatively be modified to include fewer elements than those illustrated in FIGS. 1A and 1B, provided that housing 104 encloses at least part of antenna 106.

As seen most clearly at enlargement 130, antenna 106 is preferably fed by way of a coaxial cable 132 connected to feed point 114. Antenna 106 is preferably supported by a multiplicity of non-conductive columns 134 formed on a dedicated non-conductive carrier 136, which carrier 136 is preferably attached to an inner circumference 138 of heat sink 124. The use of a dedicated non-conductive carrier, such as carrier 136, to support antenna 106 allows the height and centration of antenna 106 with respect to heat sink 124 to be precisely controlled. As a result, the influence of the conductive structure formed by heat sink 124 on the radiation properties of antenna 106 may be advantageously utilized.

It is appreciated that antenna 106 may alternatively be mounted on a pre-existing inner surface of lighting device 100, whereby dedicated carrier 136 may be obviated, as will be exemplified henceforth.

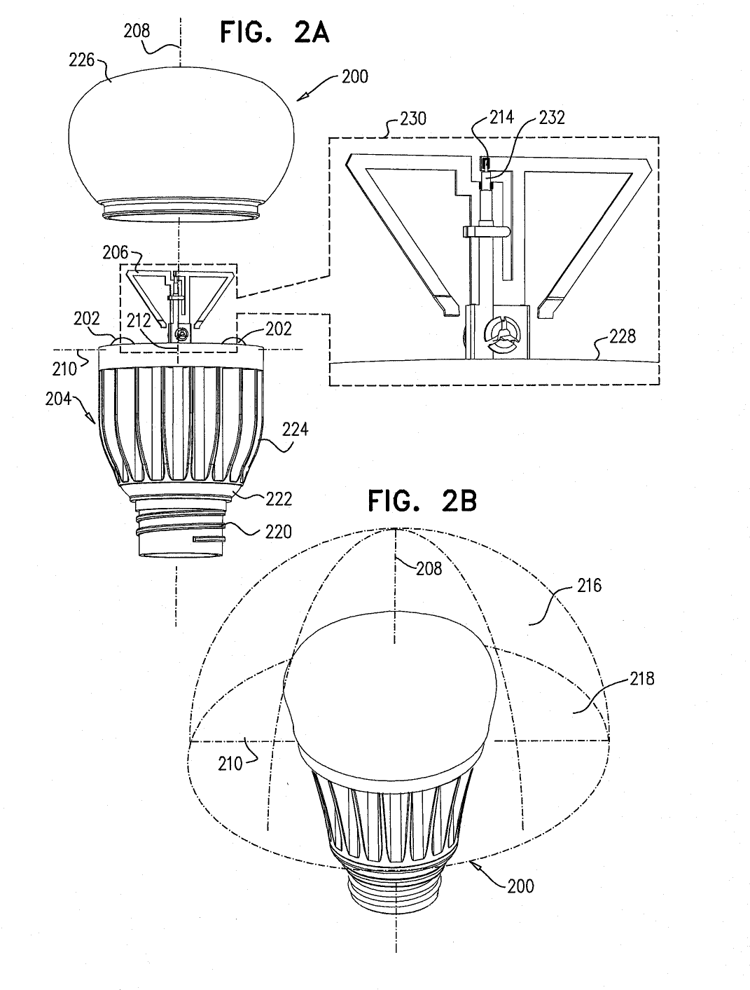

Reference is now made to FIGS. 2A and 2B, which are simplified respective exploded and assembled view illustrations of a lighting device constructed and operative in accordance with another preferred embodiment of the present invention.

As seen in FIGS. 2A and 2B, there is provided a lighting device 200 including at least one light source, here embodied, by way of example, as a multiplicity of LEDs 202, two of which LEDs are visible in FIG. 2A. Lighting device 200 further includes a housing 204 enclosing an antenna 206 and defining a longitudinal axis 208 and a lateral axis 210, which axes 208 and 210 preferably intersect at a point 212. Antenna 206 receives an RF input signal at a feed point 214 and is operative to emit RF radiation over a predetermined frequency range. Antenna 206 may hence be employed for wireless control and/or monitoring of the operation of lighting device 200.

It is a particular feature of a preferred embodiment of the present invention that more than half of the energy radiated by antenna 206 is radiated in a direction within a hemisphere 216, which hemisphere 216 is symmetric about the longitudinal axis 208 and has an equatorial plane 218 in which the lateral axis 210 extends.

Antenna 206 is preferably embodied as an upstanding quasi-planar triangular-like element, preferably offset from LEDs 202. It is a further particular feature of a preferred embodiment of the present invention that, despite its proximity to LEDs 202, antenna 206 preferably has a negligible effect on the light emissive properties of LEDs 202 due to its structure and location with respect to LEDs 202.

As seen most clearly in FIG. 2A, housing 204 preferably includes a socket 220, by way of which socket 220 lighting device 200 is preferably connected to a power supply (not shown). It is appreciated from consideration of FIGS. 2A and 2B that hemisphere 216 is preferably directed away from socket 220 such that more than half of the energy emitted by antenna 206 is radiated in a direction away from the power supply of lighting device 200.

A narrow base 222 preferably emerges from socket 220, which base 222 preferably abuts a metallic heat sink 224. Housing 204 preferably further includes a bulb cover 226 preferably affixed to an upper rim 228 of heat sink 224, through which bulb cover 226 light emitted by LEDs 202 is transmitted. As seen most clearly at enlargement 230, antenna 206 is preferably fed by way of a coaxial cable 232 connected to feed point 214. Antenna 206 is preferably supported by a dedicated non-conductive carrier (not shown) preferably attached to heat sink 124.

It is appreciated that, with the exception of the above-outlined differences in structure and arrangement between single LED 102 and ring antenna 106 of FIGS. 1A and 1B and multiplicity of LEDs 202 and triangular antenna 206 of FIGS. 2A and 2B, lighting device 200 may generally resemble lighting device 100 in every relevant respect. In particular, it is appreciated that lighting device 200 shares the features and advantages described above with reference to lighting device 100, including the optimization of the radiation pattern of antenna 206 for wireless control and/or monitoring of lighting device 200, without significantly interfering with the light emissive properties of lighting device 200.

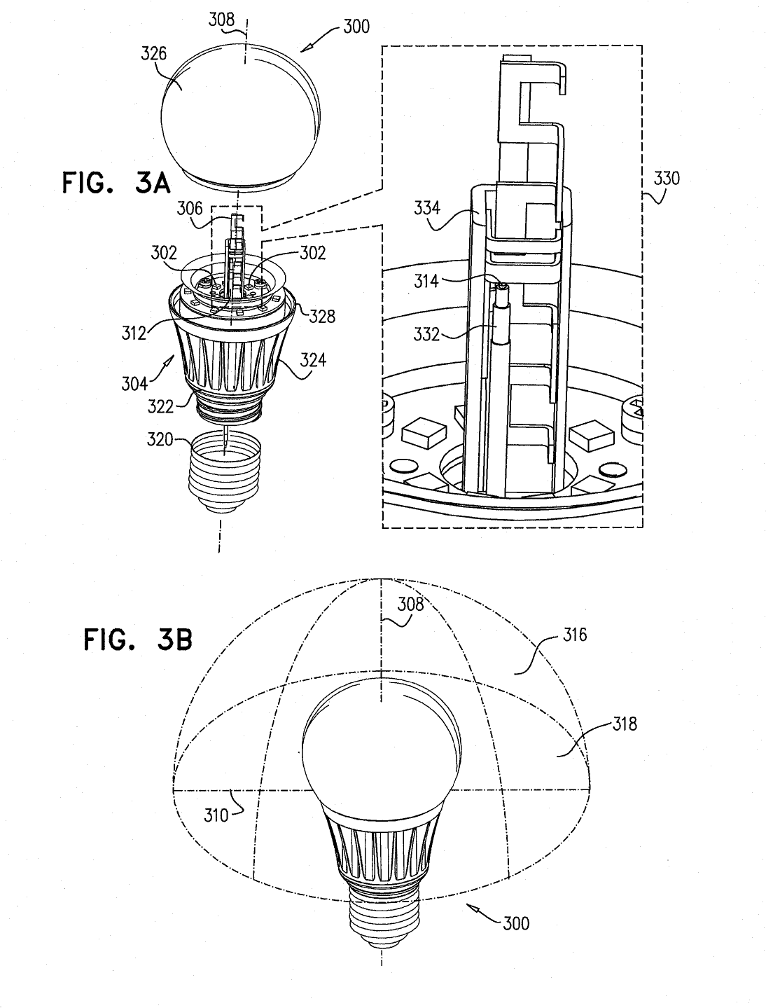

Reference is now made to FIGS. 3A and 3B, which are simplified respective exploded and assembled view illustrations of a lighting device constructed and operative in accordance with yet another preferred embodiment of the present invention.

As seen in FIGS. 3A and 3B, there is provided a lighting device 300 including at least one light source, here embodied, by way of example, as a multiplicity of LEDs 302. Lighting device 300 further includes a housing 304 enclosing an antenna 306 and defining a longitudinal axis 308 and a lateral axis 310, which axes 308 and 310 preferably intersect at a point 312. Antenna 306 receives an RF input signal at a feed point 314 and is operative to emit RF radiation over a predetermined frequency range. Antenna 306 may hence be employed for wireless control and/or monitoring of the operation of lighting device 300.

It is a particular feature of a preferred embodiment of the present invention that more than half of the energy radiated by antenna 306 is radiated in a direction within a hemisphere 316, which hemisphere 316 is symmetric about the longitudinal axis 308 and has an equatorial plane 318 in which the lateral axis 310 extends.

Antenna 306 is preferably embodied as an upstanding meandering element, preferably concentrically located with respect to LEDs 302. It is a further particular feature of a preferred embodiment of the present invention that, despite its proximity to LEDs 302, antenna 306 preferably has a negligible effect on the light emissive properties of LEDs 302 due to its upstanding structure and central location with respect to LEDs 302.

As seen most clearly in FIG. 3A, housing 304 preferably includes a socket 320, by way of which socket 320 lighting device 300 is preferably connected to a power supply (not shown). It is appreciated from consideration of FIGS. 3A and 3B that hemisphere 316 is preferably directed away from socket 320 such that more than half of the energy emitted by antenna 306 is radiated in a direction away from the power supply of lighting device 300.

A narrow base 322 preferably emerges from socket 320, which base 322 preferably abuts a metallic heat sink 324. Housing 304 further preferably includes a bulb cover 326 preferably affixed to an upper rim 328 of heat sink 324, through which bulb cover 326 light emitted by LEDs 302 is transmitted. As seen most clearly at enlargement 330, antenna 306 is preferably fed by way of a coaxial cable 332 connected to feed point 314. Antenna 306 is preferably supported by a dedicated non-conductive carrier 334.

It is appreciated that, with the exception of the above-outlined differences in structure and arrangement between triangular antenna 206 of FIGS. 2A and 2B and meandering antenna 306 of FIGS. 3A and 3B, lighting device 300 may generally resemble lighting device 200 in every relevant respect. In particular, it is appreciated that lighting device 300 shares the features and advantages described above with reference to lighting device 200, including the optimization of the radiation pattern of antenna 306 for wireless control and/or monitoring of lighting device 300, without significantly interfering with the light emissive properties of lighting device 300.

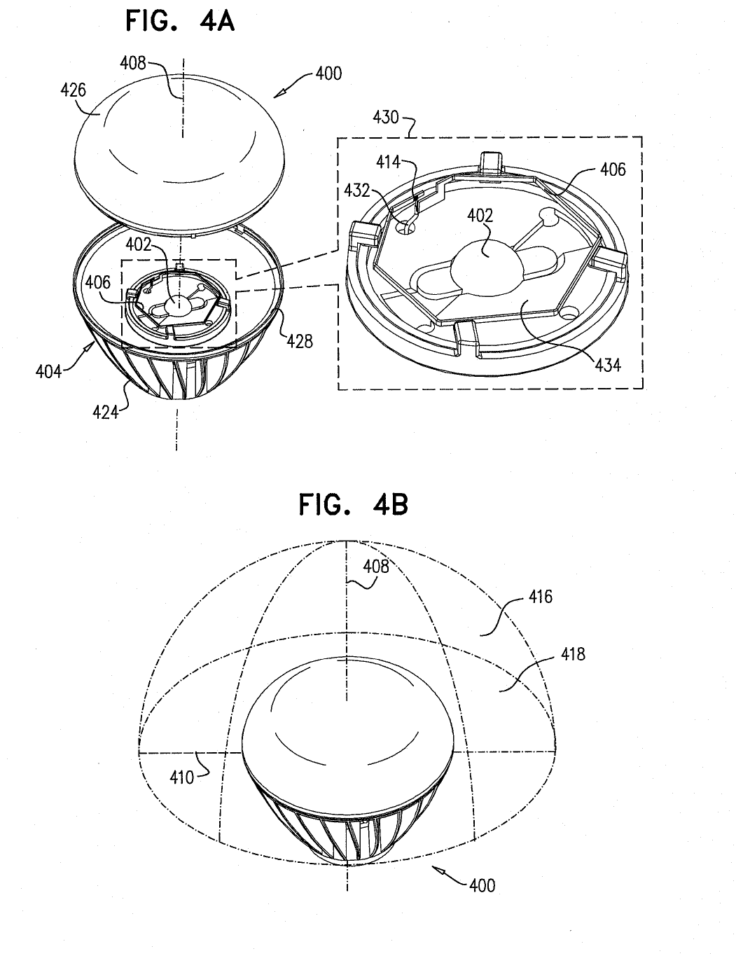

Reference is now made to FIGS. 4A and 4B, which are simplified respective exploded and assembled view illustrations of a lighting device constructed and operative in accordance with a further preferred embodiment of the present invention.

As seen in FIGS. 4A and 4B, there is provided a lighting device 400 including at least one light source, here embodied, by way of example, as a single LED 402. Lighting device 400 further includes a housing 404 enclosing an antenna 406 and defining a longitudinal axis 408 and a lateral axis 410, which axes 408 and 410 preferably intersect at a central point. Antenna 406 receives an RF input signal at a feed point 414 and is operative to emit RF radiation over a predetermined frequency range. Antenna 406 may hence be employed for wireless control and/or monitoring of the operation of lighting device 400.

It is a particular feature of a preferred embodiment of the present invention that more than half of the energy radiated by antenna 406 is radiated in a direction within a hemisphere 416, which hemisphere 416 is symmetric about the longitudinal axis 408 and has an equatorial plane 418 in which the lateral axis 410 extends.

Antenna 406 is preferably embodied as a heptagonal element, preferably located concentrically above LED 402. It is a further particular feature of a preferred embodiment of the present invention that, despite its proximity to LED 402, antenna 406 preferably has a negligible effect on the light emissive properties of LED 402 due to the ring-shaped structure of antenna 406 which offers minimal obstruction to light emission from LED 402.

As seen most clearly in FIG. 4A, housing 404 preferably includes a metallic heat sink 424 and a bulb cover 426 preferably affixed to an upper rim 428 of heat sink 424, through which bulb cover 426 light emitted by LED 402 is transmitted. As seen most clearly at enlargement 430, antenna 406 is preferably a single-feed antenna, preferably fed by a coaxial cable 432. Antenna 406 is preferably supported by a dedicated non-conductive carrier 434 preferably attached to heat sink 424. Lighting device 400 is preferably connected to a power supply by means of a power socket (not shown), preferably located adjacent to heat sink 424.

It is appreciated that, with the exception of the above-outlined differences in structure and arrangement between ring antenna 106 of FIGS. 1A and 1B and heptagonal antenna 406 of FIGS. 4A and 4B, lighting device 400 may generally resemble lighting device 100 in every relevant respect. In particular, it is appreciated that lighting device 400 shares the features and advantages described above with reference to lighting device 100, including the optimization of the radiation pattern of antenna 406 for wireless control and/or monitoring of lighting device 400, without significantly interfering with the light emissive properties of lighting device 400.

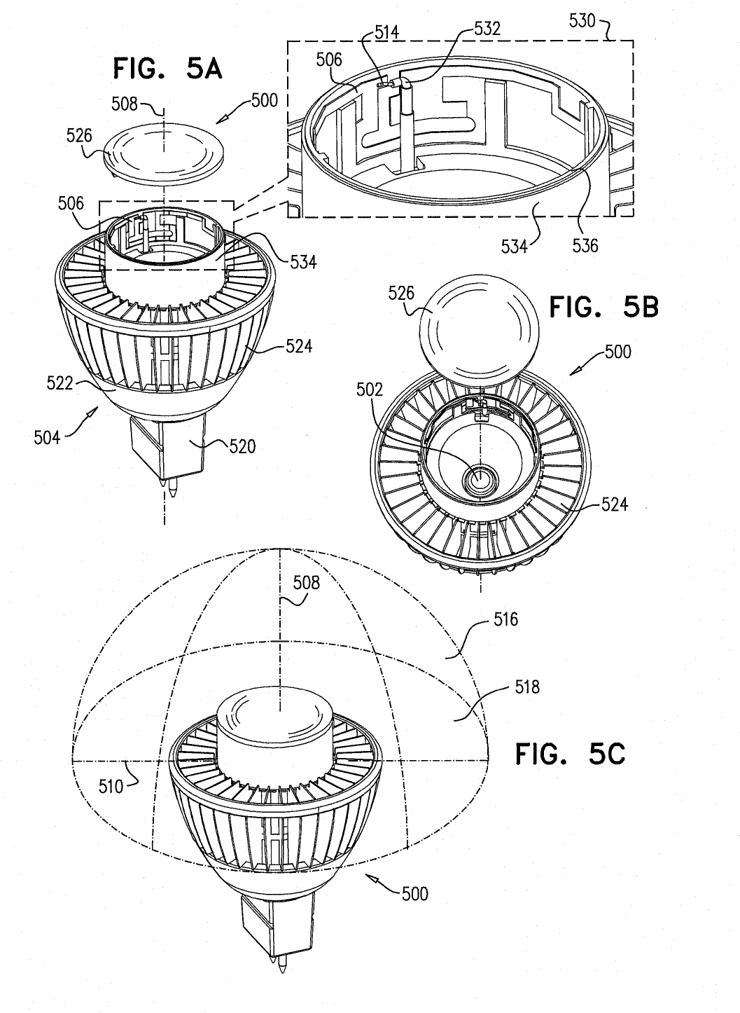

Reference is now made to FIGS. 5A, 5B and 5C, which are simplified respective perspective and top exploded and assembled view illustrations of a lighting device constructed and operative in accordance with yet a further preferred embodiment of the present invention.

As seen in FIGS. 5A-5C, there is provided a lighting device 500 including at least one light source, here embodied, by way of example, as a single LED 502, as seen most clearly in FIG. 5B. Lighting device 500 further includes a housing 504 enclosing an antenna 506 and defining a longitudinal axis 508 and a lateral axis 510, which axes 508 and 510 preferably intersect at a central point. Antenna 506 receives an RF input signal at a feed point 514 and is operative to emit RF radiation over a predetermined frequency range. Antenna 506 may hence be employed for wireless control and/or monitoring of the operation of lighting device 500.

It is a particular feature of a preferred embodiment of the present invention that more than half of the energy radiated by antenna 506 is radiated in a direction within a hemisphere 516, which hemisphere 516 is symmetric about the longitudinal axis 508 and has an equatorial plane 518 in which the lateral axis 510 extends.

Antenna 506 is preferably embodied as a meandering element following a curved contour and offset to a side of LED 502. It is a further particular feature of a preferred embodiment of the present invention that, despite its proximity to LED 502, antenna 506 preferably has a negligible effect on the light emissive properties of LED 502 due to its lateral location with respect to LED 502.

As seen most clearly in FIG. 5A, housing 504 preferably includes a socket 520, by way of which socket 520 lighting device 500 is preferably connected to a power supply (not shown). It is appreciated from consideration of FIGS. 5A and 5C that hemisphere 516 is preferably directed away from socket 520 such that more than half of the energy emitted by antenna 506 is radiated in a direction away from the power supply of lighting device 500.

A narrow base 522 preferably emerges from socket 520, which base 522 preferably abuts a metallic heat sink 524. Housing 504 further preferably includes a bulb cover 526 through which bulb cover 526 light emitted by LED 502 is transmitted. As seen most clearly at enlargement 530, antenna 506 is preferably fed by way of a coaxial cable 532 connected to feed point 514. Antenna 506 is preferably formed on an inner surface of a dedicated cylindrical plastic carrier 534 preferably attached to an inner circumference of heat sink 124. Bulb cover 526 is preferably affixed to an upper rim 536 of plastic carrier 534.

It is appreciated that, with the exception of the above-outlined differences in structure and arrangement between ring antenna 106 of FIGS. 1A and 1B and meandering antenna 506 of FIGS. 5A-5C, lighting device 500 may generally resemble lighting device 100 in every relevant respect. In particular, it is appreciated that lighting device 500 shares the features and advantages described above with reference to lighting device 100, including the optimization of the radiation pattern of antenna 506 for wireless control and/or monitoring of lighting device 500, without significantly interfering with the light emissive properties of lighting device 500.

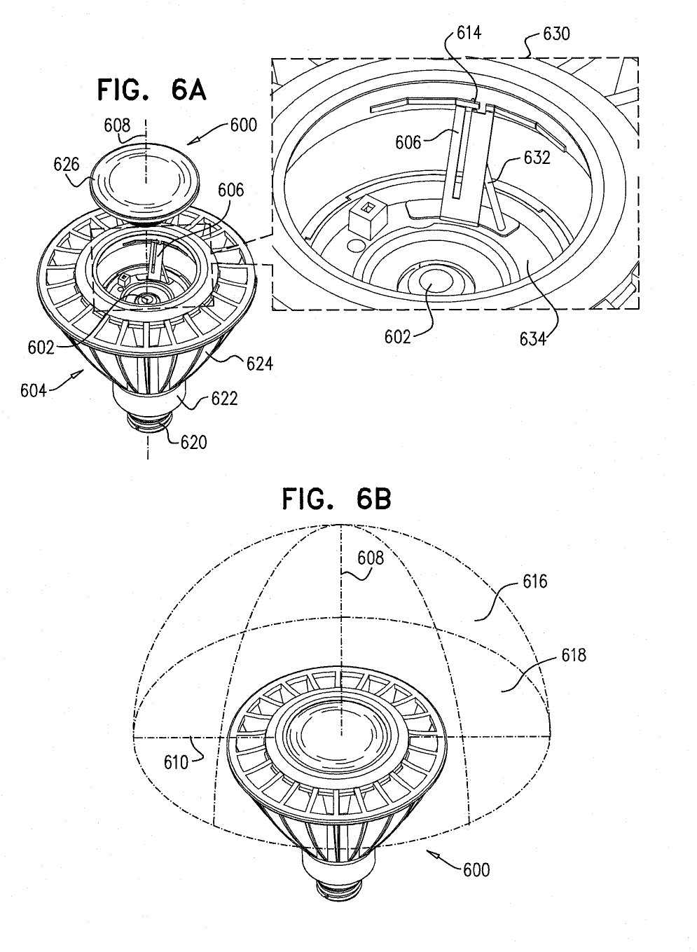

Reference is now made to FIGS. 6A and 6B, which are simplified respective exploded and assembled view illustrations of a lighting device constructed and operative in accordance with another preferred embodiment of the present invention.

As seen in FIGS. 6A and 6B, there is provided a lighting device 600 including at least one light source, here embodied, by way of example, as a single LED 602, as seen most clearly in FIG. 6A. Lighting device 600 further includes a housing 604 enclosing an antenna 606 and defining a longitudinal axis 608 and a lateral axis 610, which axes 608 and 610 preferably intersect at a central point. Antenna 606 receives an RF input signal at a feed point 614 and is operative to emit RF radiation over a predetermined frequency range. Antenna 606 may hence be employed for wireless control and/or monitoring of the operation of lighting device 600.

It is a particular feature of a preferred embodiment of the present invention that more than half of the energy radiated by antenna 606 is radiated in a direction within a hemisphere 616, which hemisphere 616 is symmetric about the longitudinal axis 608 and has an equatorial plane 618 in which the lateral axis 610 extends.

Antenna 606 is preferably embodied as an upstanding dual-branched element offset to one side of LED 602. It is a further particular feature of a preferred embodiment of the present invention that, despite its proximity to LED 602, antenna 606 preferably has a negligible effect on the light emissive properties of LED 602 due to its upstanding and lateral location with respect to LED 602.

As seen most clearly in FIG. 6A, housing 604 preferably includes a socket 620, by way of which socket 620 lighting device 600 is preferably connected to a power supply (not shown). It is appreciated from consideration of Figs. GA and 6B that hemisphere 616 is preferably directed away from socket 620 such that more than half of the energy emitted by antenna 606 is radiated in a direction away from the power supply of lighting device 600.

A narrow base 622 preferably emerges from socket 620, which base 622 preferably abuts a metallic heat sink 624. Housing 604 further preferably includes a bulb cover 626 affixed to an upper rim of heat sink 624 through which bulb cover 626 light emitted by LED 602 is transmitted. As seen most clearly at enlargement 630, antenna 606 is preferably fed by way of a coaxial cable 632 connected to feed point 614. In contrast to the above-described embodiments of antennas 106-506, in each of which embodiments the antenna is preferably supported by a dedicated carrier specifically provided for that purpose, antenna 606 is preferably mounted on a plastic ring 634, which ring 634 also functions as a holder for LED 602.

It is appreciated that, with the exception of the above-outlined differences in structure and arrangement between ring antenna 106 of FIGS. 1A and 1B supported by dedicated carrier 136 and dual-branched antenna 606 of FIGS. 6A and 6B supported on LED holder 634, lighting device 600 may generally resemble lighting device 100 in every relevant respect. In particular, it is appreciated that lighting device 600 shares the features and advantages described above with reference to lighting device 100, including the optimization of the radiation pattern of antenna 606 for wireless control and/or monitoring of lighting device 600, without significantly interfering with the light emissive properties of lighting device 600.

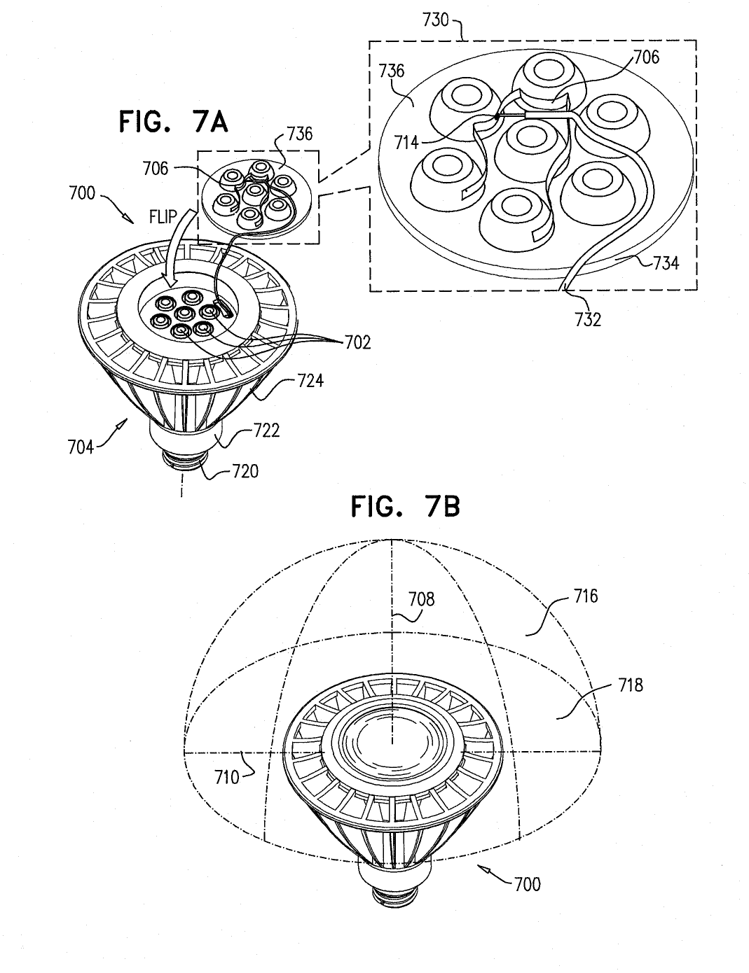

Reference is now made to FIGS. 7A and 7B, which are simplified respective exploded and assembled view illustrations of a lighting device constructed and operative in accordance with still another preferred embodiment of the present invention.

As seen in FIGS. 7A and 7B, there is provided a lighting device 700 including at least one light source, here embodied, by way of example, as a multiplicity of LEDs 702, as seen most clearly in FIG. 7A. Lighting device 700 further includes a housing 704 enclosing an antenna 706 and defining a longitudinal axis 708 and a lateral axis 710, which axes 708 and 710 preferably intersect at a central point. Antenna 706 receives an RF input signal at a feed point 714 and is operative to emit RF radiation over a predetermined frequency range. Antenna 706 may hence be employed for wireless control and/or monitoring of the operation of lighting device 700.

It is a particular feature of a preferred embodiment of the present invention that more than half of the energy radiated by antenna 706 is radiated in a direction within a hemisphere 716, which hemisphere 716 is symmetric about the longitudinal axis 708 and has an equatorial plane 718 in which the lateral axis 710 extends.

Antenna 706 is preferably embodied as a meandering strip woven between multiplicity of LEDs 702 so as not to obstruct light emission from LEDs 702. It is a further particular feature of a preferred embodiment of the present invention that, despite its proximity to LEDs 702, antenna 706 preferably has a negligible effect on the light emissive properties of LEDs 702 due to its location with respect to LEDs 702.

As seen most clearly in FIG. 7A, housing 704 preferably includes a socket 720, by way of which socket 720 lighting device 700 is preferably connected to a power supply (not shown). It is appreciated from consideration of FIGS. 7A and 7B that hemisphere 716 is preferably directed away from socket 720 such that more than half of the energy emitted by antenna 706 is radiated in a direction away from the power supply of lighting device 700.

A narrow base 722 preferably emerges from socket 720, which base 722 preferably abuts a metallic heat sink 724. As seen most clearly at enlargement 730, antenna 706 is preferably fed by way of a coaxial cable 732 connected to feed point 714.

Lighting device 700 further preferably includes a collimator 734 preferably positioned above LEDs 702. It is a particular feature of a preferred embodiment of the present invention that antenna 706 is preferably located on a lower surface 736 of collimator 734, thereby obviating the need for a dedicated antenna carrier.

It is appreciated that, with the exception of the above-outlined differences in structure and arrangement between ring antenna 106 of FIGS. 1A and 1B supported by dedicated carrier 136 and meandering antenna 706 of FIGS. 7A and 7B supported by collimator 734, lighting device 700 may generally resemble lighting device 100 in every relevant respect. In particular, it is appreciated that lighting device 700 shares the features and advantages described above with reference to lighting device 100, including the optimization of the radiation pattern of antenna 706 for wireless control and/or monitoring of lighting device 700, without significantly interfering with the light emissive properties of lighting device 700.

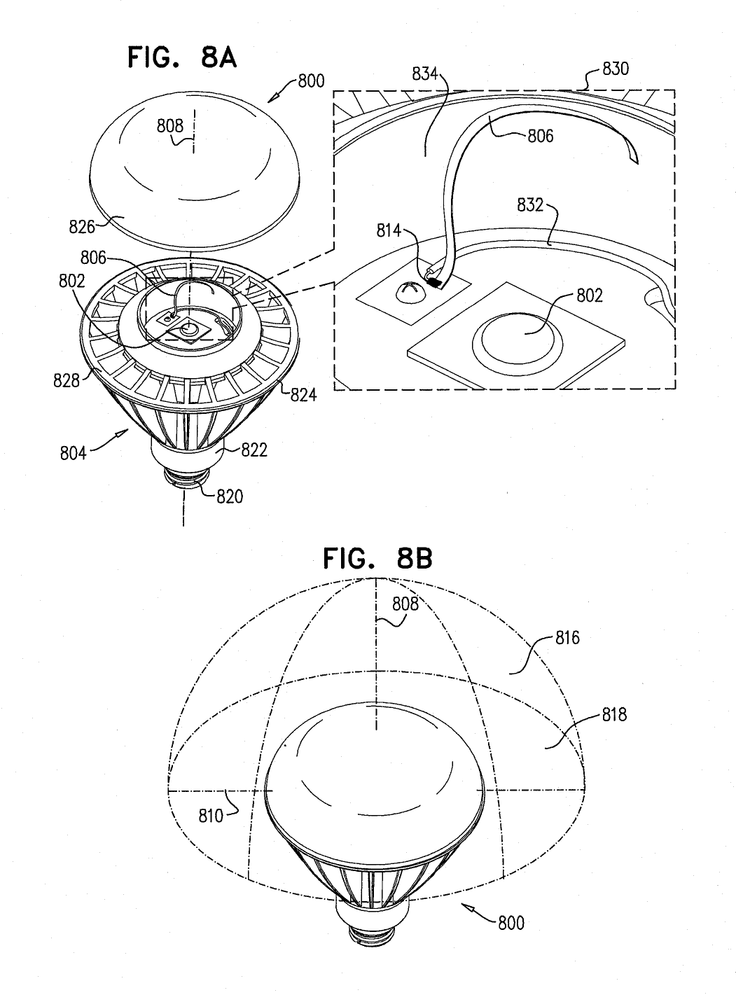

Reference is now made to FIGS. 8A and 8B, which are simplified respective exploded and assembled view illustrations of a lighting device constructed and operative in accordance with a still further preferred embodiment of the present invention.

As seen in FIGS. 8A and 8B, there is provided a lighting device 800 including at least one light source, here embodied, by way of example, as a single LED 802, as seen most clearly in FIG. 8A. Lighting device 800 further includes a housing 804 enclosing an antenna 806 and defining a longitudinal axis 808 and a lateral axis 810, which axes 808 and 810 preferably intersect at a central point. Antenna 806 receives an RF input signal at a feed point 814 and is operative to emit RF radiation over a predetermined frequency range. Antenna 806 may hence be employed for wireless control and/or monitoring of the operation of lighting device 800.

It is a particular feature of a preferred embodiment of the present invention that more than half of the energy radiated by antenna 806 is radiated in a direction within a hemisphere 816, which hemisphere 816 is symmetric about the longitudinal axis 808 and has an equatorial plane 818 in which the lateral axis 810 extends.

Antenna 806 is preferably embodied as an arched strip offset to one side of LED 802. It is a further particular feature of a preferred embodiment of the present invention that, despite its proximity to LED 802, antenna 806 preferably has a negligible effect on the light emissive properties of LED 802 due to its lateral location with respect to LED 802.

As seen most clearly in FIG. 8A, housing 804 preferably includes a socket 820, by way of which socket 820 lighting device 800 is preferably connected to a power supply (not shown). It is appreciated from consideration of FIGS. 8A and 8B that hemisphere 816 is preferably directed away from socket 820 such that more than half of the energy emitted by antenna 806 is radiated in a direction away from the power supply of lighting device 800.

A narrow base 822 preferably emerges from socket 820, which base 822 preferably abuts a metallic heat sink 824. Housing 804 further preferably includes a bulb cover 826 affixed to an upper rim 828 of heat sink 824 through which bulb cover 826 light emitted by LED 802 is transmitted. As seen most clearly at enlargement 830, antenna 806 is preferably fed by way of a coaxial cable 832 connected to feed point 814.

It is a particular feature of a preferred embodiment of the present invention that antenna 806 rest on an inner surface 834 of heat sink 824, thereby obviating the need for a dedicated antenna carrier.

It is appreciated that, with the exception of the above-outlined differences in structure and arrangement between meandering antenna 706 of FIGS. 7A and 7B supported by collimator 734 and arched antenna 806 of FIGS. 8A and 8B supported by heat sink 824, lighting device 800 may generally resemble lighting device 700 in every relevant respect. In particular, it is appreciated that lighting device 800 shares the features and advantages described above with reference to lighting device 700, including the optimization of the radiation pattern of antenna 806 for wireless control and/or monitoring of lighting device 800, without significantly interfering with the light emissive properties of lighting device 800.

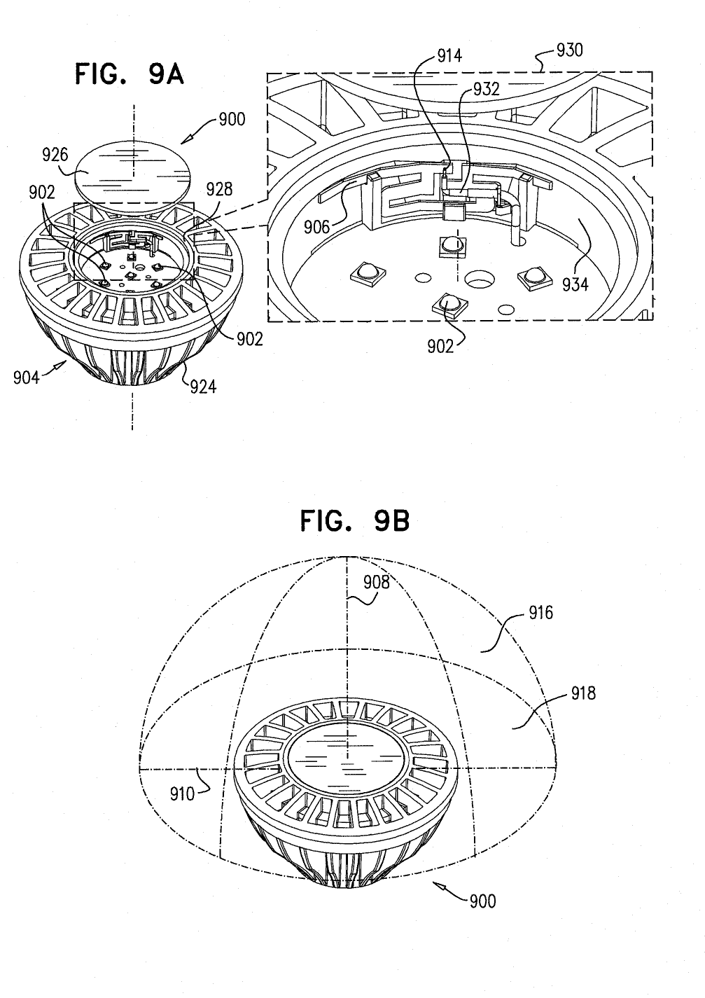

Reference is now made to FIGS. 9A and 9B, which are simplified respective exploded and assembled view illustrations of a lighting device constructed and operative in accordance with another preferred embodiment of the present invention.

As seen in FIGS. 9A and 9B, there is provided a lighting device 900 including at least one light source, here embodied, by way of example, as an array of seven LEDs 902, as seen most clearly in FIG. 9A. It is appreciated that the provision of seven LEDs 902 in lighting device 900 is exemplary only and that lighting device 900 may include a greater or fewer number of light sources, depending on its design requirements.

Lighting device 900 further includes a housing 904 enclosing an antenna 906 and defining a longitudinal axis 908 and a lateral axis 910, which axes 908 and 910 preferably intersect at a central point. Antenna 906 receives an RF input signal at a feed point 914 and is operative to emit RF radiation over a predetermined frequency range. Antenna 906 may hence be employed for wireless control and/or monitoring of the operation of lighting device 900.

It is a particular feature of a preferred embodiment of the present invention that more than half of the energy radiated by antenna 906 is radiated in a direction within a hemisphere 916, which hemisphere 916 is symmetric about the longitudinal axis 908 and has an equatorial plane 918 in which the lateral axis 910 extends.

Antenna 906 is preferably embodied as an erect meandering element following a curved contour and offset to one side of array of LEDs 902. It is a further particular feature of a preferred embodiment of the present invention that, despite its proximity to array of LEDs 902, antenna 906 preferably has a negligible effect on the light emissive properties of LEDs 902 due to its erect configuration and lateral location with respect to LEDs 902.

Housing 904 preferably includes a thermally conducting plastic heat sink 924 and a bulb cover 926, which bulb cover 926 is preferably affixed to an upper rim 928 of heat sink 924. As seen most clearly at enlargement 930, antenna 906 is preferably fed by way of a coaxial cable 932 connected to feed point 914. In contrast to the above-described embodiments of antennas 106-506, in each of which embodiments the antenna is preferably supported by a dedicated carrier specifically provided for that purpose, antenna 906 is preferably mounted on an inner surface 934 of heat sink 924.

It is appreciated that, with the exception of the above-outlined differences in structure and arrangement between ring antenna 106 of FIGS. 1A and 1B supported by dedicated carrier 136 and meandering antenna 906 of FIGS. 9A and 9B mounted on heat sink 924, lighting device 900 may generally resemble lighting device 100 in every relevant respect. In particular, it is appreciated that lighting device 900 shares the features and advantages described above with reference to lighting device 100, including the optimization of the radiation pattern of antenna 906 for wireless control and/or monitoring of lighting device 900, without significantly interfering with the light emissive properties of lighting device 900.

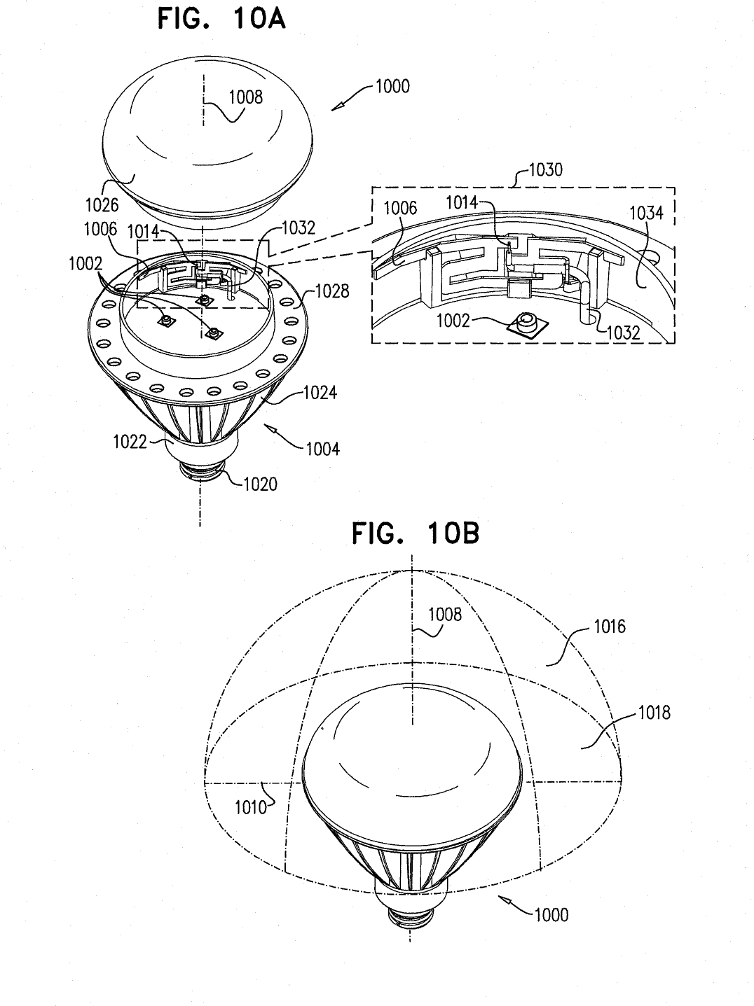

Reference is now made to FIGS. 10A and 10B, which are simplified respective exploded and assembled view illustrations of a lighting device constructed and operative in accordance with yet another preferred embodiment of the present invention.

As seen in FIGS. 10A and 10B, there is provided a lighting device 1000 including at least one light source, here embodied, by way of example, as an array of three LEDs 1002, as seen most clearly in FIG. 10A. It is appreciated that the provision of three LEDs 1002 in lighting device 1000 is exemplary only and that lighting device 1000 may include a greater or fewer number of light sources, depending on its design requirements.

Lighting device 1000 further includes a housing 1004 enclosing an antenna 1006 and defining a longitudinal axis 1008 and a lateral axis 1010, which axes 1008 and 1010 preferably intersect at a central point. Antenna 1006 receives an RF input signal at a feed point 1014 and is operative to emit RF radiation over a predetermined frequency range. Antenna 1006 may hence be employed for wireless control and/or monitoring of the operation of lighting device 1000.

It is a particular feature of a preferred embodiment of the present invention that more than half of the energy radiated by antenna 1006 is radiated in a direction within a hemisphere 1016, which hemisphere 1016 is symmetric about the longitudinal axis 1008 and has an equatorial plane 1018 in which the lateral axis 1010 extends.

Antenna 1006 is preferably embodied as an erect meandering element following a curved contour and offset to one side of LEDs 1002. It is a further particular feature of a preferred embodiment of the present invention that, despite its proximity to LEDs 1002, antenna 1006 preferably has a negligible effect on the light emissive properties of LEDs 1002 due to its erect configuration and lateral location with respect to LEDs 1002.

Housing 1004 preferably includes a socket 1020, a base 1022, a ceramic heat sink 1024 and a bulb cover 1026, which bulb cover 1026 is preferably affixed to an upper rim 1028 of heat sink 1024. It is appreciated from consideration of FIGS. 10A and 10B that hemisphere 1016 is preferably directed away from socket 1020 such that more than half of the energy emitted by antenna 1006 is radiated in a direction away from the power supply of lighting device 1000. As seen most clearly at enlargement 1030, antenna 1006 is preferably fed by way of a coaxial cable 1032 connected to feed point 1014. It is appreciated that bulb cover 1026 may alternatively be replaced by a collimator, depending on the design requirements of lighting device 1000.

It is a particular feature of a preferred embodiment of the present invention that antenna 1006 is formed on an inner wall 1034 of ceramic heat sink 1024, thereby obviating the need for a dedicated antenna carrier.

It is appreciated that, with the exception of the above-outlined differences in structure and arrangement between antenna 906 of FIGS. 9A and 9B mounted on metal heat sink 924 and antenna 1006 of FIGS. 10A and 10B mounted on ceramic heat sink 1024, lighting device 1000 may generally resemble lighting device 900 in every relevant respect. In particular, it is appreciated that lighting device 1000 shares the features and advantages described above with reference to lighting device 900, including the optimization of the radiation pattern of antenna 1006 for wireless control and/or monitoring of lighting device 1000, without significantly interfering with the light emissive properties of lighting device 1000.

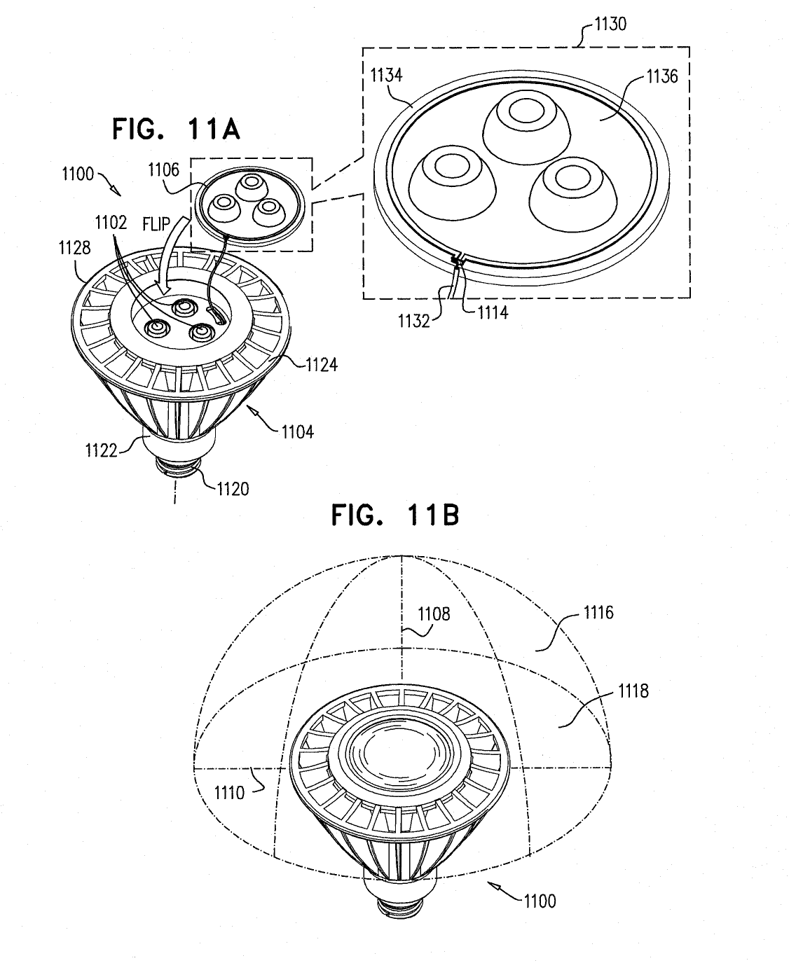

Reference is now made to FIGS. 11A and 11B, which are simplified respective exploded and assembled view illustrations of a lighting device constructed and operative in accordance with a further preferred embodiment of the present invention.

As seen in FIGS. 11A and 11B, there is provided a lighting device 1100 including at least one light source, here embodied, by way of example, as an array of three LEDs 1102, as seen most clearly in FIG. 11A. Lighting device 1100 further includes a housing 1104 enclosing an antenna 1106 and defining a longitudinal axis 1108 and a lateral axis 1110, which axes 1108 and 1110 preferably intersect at a central point. Antenna 1106 receives an RF input signal at a feed point 1114 and is operative to emit RF radiation over a predetermined frequency range. Antenna 1106 may hence be employed for wireless control and/or monitoring of the operation of lighting device 1100.

It is a particular feature of a preferred embodiment of the present invention that more than half of the energy radiated by antenna 1106 is radiated in a direction within a hemisphere 1116, which hemisphere 1116 is symmetric about the longitudinal axis 1108 and has an equatorial plane 1118 in which the lateral axis 1110 extends.

Antenna 1106 is preferably embodied as a ring-like radiating element offset above and encircling array of LEDs 1102. It is a further particular feature of a preferred embodiment of the present invention that, despite its proximity to LEDs 1102, antenna 1106 preferably has a negligible effect on the light emissive properties of LEDs 1102 due to its location with respect to LEDs 1102.

As seen most clearly in FIG. 11A, housing 1104 preferably includes a socket 1120, by way of which socket 1120 lighting device 1100 is preferably connected to a power supply (not shown). It is appreciated from consideration of FIGS. 11A and 11B that hemisphere 1116 is preferably directed away from socket 1120 such that more than half of the energy emitted by antenna 1106 is radiated in a direction away from the power supply of lighting device 1100.

A narrow base 1122 preferably emerges from socket 1120, which base 1122 preferably abuts a ceramic heat sink 1124 having an outer rim 1128. As seen most clearly at enlargement 1130, antenna 1106 is preferably fed by way of a coaxial cable 1132 connected to feed point 1114.

Lighting device 1100 further preferably includes a collimator 1134 preferably positioned above LEDs 1102. It is a particular feature of a preferred embodiment of the present invention that antenna 1106 is formed on a lower surface 1136 of collimator 1134, thereby obviating the need for a dedicated antenna carrier.

It is appreciated that, with the exception of the above-outlined differences in structure and arrangement between meandering antenna 706 of FIGS. 7A and 7B supported on collimator 734 and ring antenna 1106 supported on collimator 1134, lighting device 1100 may generally resemble lighting device 700 in every relevant respect. In particular, it is appreciated that lighting device 1100 shares the features and advantages described above with reference to lighting device 700, including the optimization of the radiation pattern of antenna 1106 for wireless control and/or monitoring of lighting device 1100, without significantly interfering with the light emissive properties of lighting device 1100.

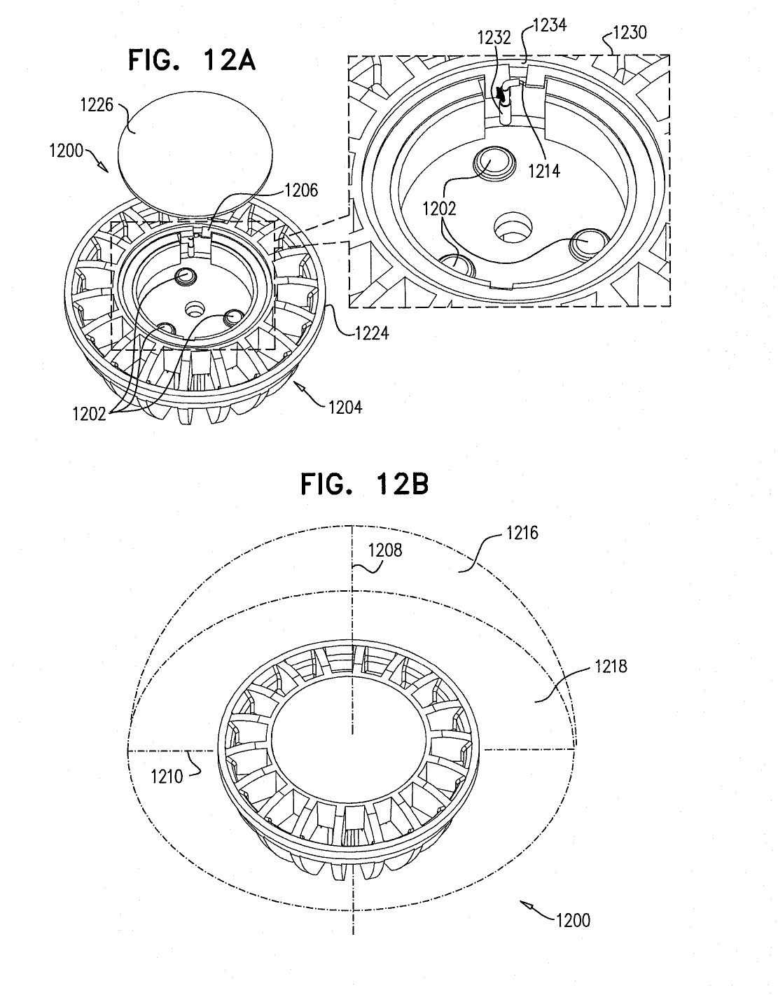

Reference is now made to FIGS. 12A and 12B, which are simplified respective exploded and assembled view illustrations of a lighting device constructed and operative in accordance with yet a further preferred embodiment of the present invention.

As seen in FIGS. 12A and 12B, there is provided a lighting device 1200 including at least one light source, here embodied, by way of example, as an array of three LEDs 1202, as seen most clearly in FIG. 12A. It is appreciated that the provision of three LEDs 1202 in lighting device 1200 is exemplary only and that lighting device 1200 may include a greater or fewer number of light sources, depending on its design requirements.

Lighting device 1200 further includes a housing 1204 enclosing an antenna 1206 and defining a longitudinal axis 1208 and a lateral axis 1210, which axes 1208 and 1210 preferably intersect at a central point. Antenna 1206 receives an RF input signal at a feed point 1214 and is operative to emit RF radiation over a predetermined frequency range. Antenna 1206 may hence be employed for wireless control and/or monitoring of the operation of lighting device 1200.

It is a particular feature of a preferred embodiment of the present invention that more than half of the energy radiated by antenna 1206 is radiated in a direction within a hemisphere 1216, which hemisphere 1216 is symmetric about the longitudinal axis 1208 and has an equatorial plane 1218 in which the lateral axis 1210 extends.

Antenna 1206 is preferably embodied as ring-like element surrounding array of LEDs 1202. It is a further particular feature of a preferred embodiment of the present invention that, despite its proximity to array of LEDs 1202, antenna 1206 preferably has a negligible effect on the light emissive properties of LEDs 1202 due to its location with respect to LEDs 1202.

Housing 1204 preferably includes a thermally conductive plastic heat sink 1224 and a bulb cover 1226, which bulb cover 1226 is preferably affixed to an inner rim of heat sink 1224. As seen most clearly at enlargement 1230, antenna 1206 is preferably fed by way of a coaxial cable 1232 connected to feed point 1214. In contrast to the above-described embodiments of antennas 106-506, in each of which embodiments the antenna is preferably supported by a dedicated carrier specifically provided for that purpose, antenna 1206 rests against an inner surface 1234 of heat sink 1224.

It is appreciated that, with the exception of the above-outlined differences in structure and arrangement between ring antenna 106 of FIGS. 1A and 1B supported by dedicated carrier 136 and ring antenna 1206 of FIGS. 12A and 12B supported by heat sink 1224, lighting device 1200 may generally resemble lighting device 100 in every relevant respect. In particular, it is appreciated that lighting device 1200 shares the features and advantages described above with reference to lighting device 100, including the optimization of the radiation pattern of antenna 1206 for wireless control and/or monitoring of lighting device 1200, without significantly interfering with the light emissive properties of lighting device 1200.

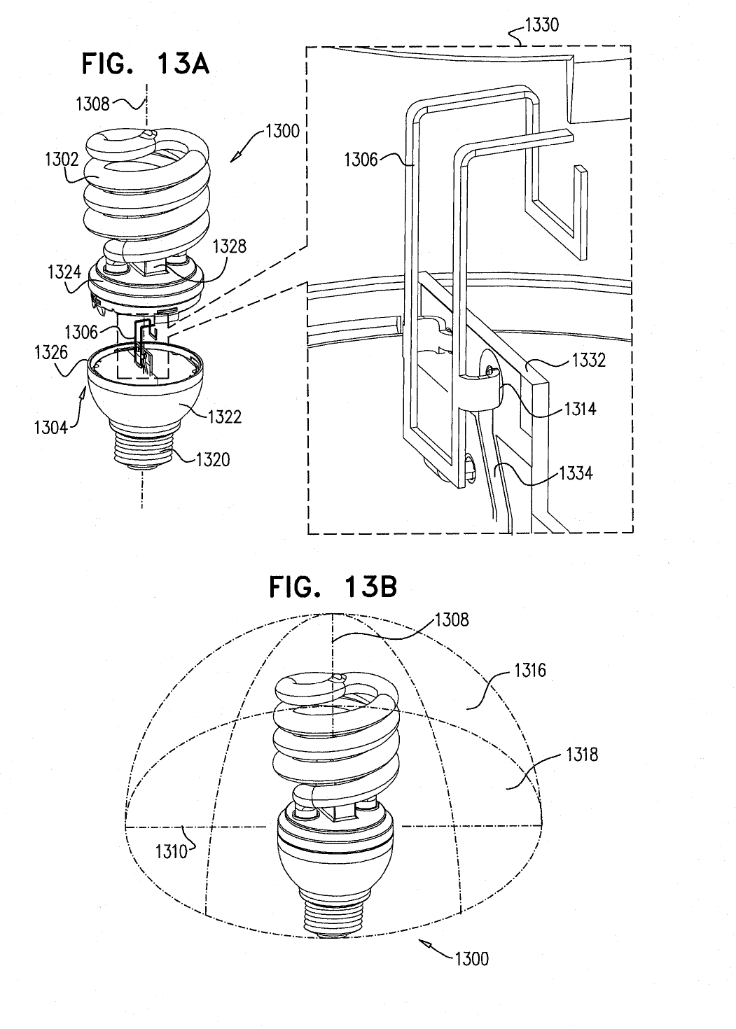

Reference is now made to FIGS. 13A and 13B, which are simplified respective exploded and assembled view illustrations of a lighting device constructed and operative in accordance with a still further preferred embodiment of the present invention.

As seen in FIGS. 13A and 13B, there is provided a lighting device 1300 including at least one light source, here embodied, by way of example, as a helical CFL 1302. It is appreciated that in this respect lighting device 1300 differs from the above-described embodiments of lighting devices 100-1200, in each of which embodiments the light source is an LED rather than CFL. It is further appreciated that the helical structure of CFL 1302 illustrated in FIGS. 13A and 13B is exemplary only and that CFL 1302 may be alternatively be configured as any other suitable CFL bulb known in the art.

Lighting device 1300 further preferably includes a housing 1304 enclosing an antenna 1306 and defining a longitudinal axis 1308 and a lateral axis 1310, which axes 1308 and 1310 preferably intersect at a central point. Antenna 1306 receives an RF input signal at a feed point 1314 and is operative to emit RF radiation over a predetermined frequency range. Antenna 1306 may hence be employed for wireless control and/or monitoring of the operation of lighting device 1300.

It is a particular feature of a preferred embodiment of the present invention that more than half of the energy radiated by antenna 1306 is radiated in a direction within a hemisphere 1316, which hemisphere 1316 is symmetric about the longitudinal axis 1308 and has an equatorial plane 1318 in which the lateral axis 1310 extends.

Antenna 1306 is preferably embodied as a three-dimensional open ended loop radiating element centrally located beneath and partially within the bore of helical CFL 1302. It is a further particular feature of a preferred embodiment of the present invention that, despite its proximity to CFL 1302, antenna 1306 preferably has a negligible effect on the light emissive properties of CFL 1302 due to its location with respect to CFL 1302.

As seen most clearly in FIG. 13A, housing 1304 preferably includes a socket 1320, by way of which socket 1320 lighting device 1300 is preferably connected to a power supply (not shown). It is appreciated from consideration of FIGS. 13A and 13B that hemisphere 1316 is preferably directed away from socket 1320 such that more than half of the energy emitted by antenna 1306 is radiated in a direction away from the power supply of lighting device 1300.

A base 1322 preferably emerges from socket 1320. An annular stand 1324 is preferably affixed to an upper rim 1326 of base 1322, on which stand 1324 CFL 1302 is mounted. A protrusion 1328 is preferably formed in stand 1324 so as to enclose antenna 1306. As seen most clearly at enlargement 1330, antenna 1306 is preferably mounted on a printed circuit board (PCB) 1332 and fed by way of a printed transmission line 1334 terminating at feed point 1314.

It is appreciated that, with the exception of the above-outlined differences in structure and arrangement between ring antenna 106 of LED lighting device 100 and open-loop antenna 1306 of CFL lighting device 1300, lighting device 1300 may generally resemble lighting device 100 in every relevant respect. In particular, it is appreciated that lighting device 1300 shares the features and advantages described above with reference to lighting device 100, including the optimization of the radiation pattern of antenna 1306 for wireless control and/or monitoring of lighting device 1300, without significantly interfering with the light emissive properties of lighting device 1300.

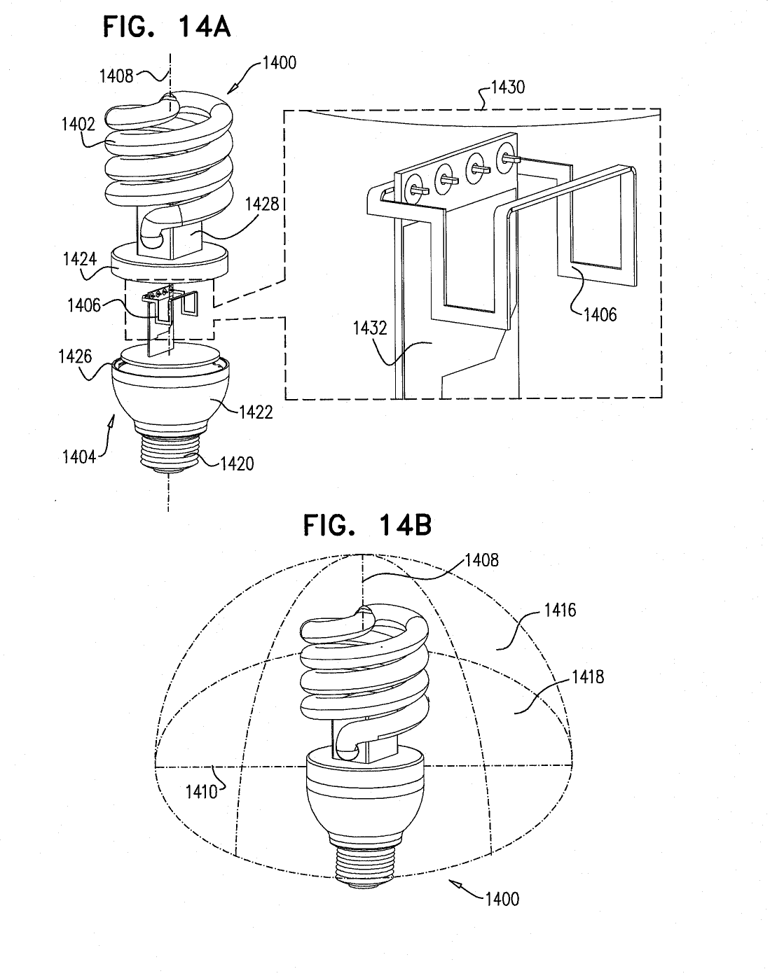

Reference is now made to FIGS. 14A and 14B, which are simplified respective exploded and assembled view illustrations of a lighting device constructed and operative in accordance with another preferred embodiment of the present invention.

As seen in FIGS. 14A and 14B, there is provided a lighting device 1400 including at least one light source, here embodied, by way of example, as a helical CFL 1402. It is appreciated that in this respect lighting device 1400 differs from the above-described embodiments of lighting devices 100-1200, in each of which embodiments the light source is an LED rather than CFL. It is further appreciated that the helical structure of CFL 1402 illustrated in FIGS. 14A and 14B is exemplary only and that CFL 1402 may be alternatively be configured as any other suitable CFL bulb known in the art.

Lighting device 1400 further preferably includes a housing 1404 enclosing an antenna 1406 and defining a longitudinal axis 1408 and a lateral axis 1410, which axes 1408 and 1410 preferably intersect at a central point. Antenna 1406 receives an RF input signal at a feed point (not shown) and is operative to emit RF radiation over a predetermined frequency range. Antenna 1406 may hence be employed for wireless control and/or monitoring of the operation of lighting device 1400.

It is a particular feature of a preferred embodiment of the present invention that more than half of the energy radiated by antenna 1406 is radiated in a direction within a hemisphere 1416, which hemisphere 1416 is symmetric about the longitudinal axis 1408 and has an equatorial plane 1418 in which the lateral axis 1410 extends.

Antenna 1406 is preferably embodied as a three-dimensional closed loop radiating element centrally located beneath and partially within the bore of helical CFL 1402. It is a further particular feature of a preferred embodiment of the present invention that, despite its proximity to CFL 1402, antenna 1406 preferably has a negligible effect on the light emissive properties of CFL 1402 due to its location with respect to CFL 1402.

As seen most clearly in FIG. 14A, housing 1404 preferably includes a socket 1420, by way of which socket 1420 lighting device 1400 is preferably connected to a power supply (not shown). It is appreciated from consideration of FIGS. 14A and 14B that hemisphere 1416 is preferably directed away from socket 1420 such that more than half of the energy emitted by antenna 1406 is radiated in a direction away from the power supply of lighting device 1400.

A base 1422 preferably emerges from socket 1420. An annular stand 1424 is preferably affixed to an upper rim 1426 of base 1422, on which stand 1424 CFL 1402 is mounted. A protrusion 1428 is preferably formed in stand 1424 so as to enclose antenna 1406. As seen most clearly at enlargement 1430, antenna 1406 is preferably mounted on a PCB 1432 and may be fed by way of a printed transmission line (not shown) formed on the PCB.

It is appreciated that, with the exception of the above-outlined differences in structure and arrangement between open-loop antenna 1306 of FIGS. 13A and 13B and closed loop antenna 1406 of FIGS. 14A and 14B, lighting device 1400 may generally resemble lighting device 1300 is every relevant respect. In particular, it is appreciated that lighting device 1400 shares the features and advantages described above with reference to lighting device 1300, including the optimization of the radiation pattern of antenna 1406 for wireless control and/or monitoring of lighting device 1400, without significantly interfering with the light emissive properties of lighting device 1400.

It will be appreciated by persons skilled in the art that the present invention is not limited by what has been particularly claimed hereinbelow. Rather, the scope of the invention includes various combinations and subcombinations of the features described hereinabove as well as modifications and variations thereof as would occur to persons skilled in the art upon reading the forgoing description with reference to the drawings and which are not in the prior art.

1. A lighting device, comprising:
at least one light source;
a housing located adjacent to said at least one light source, said housing defining a longitudinal axis and being intersected by a lateral axis; and
an antenna at least partially enclosed by said housing and located proximal to said at least one light source, said antenna being operative to radiate energy, more than half of said energy being radiated in a direction within a hemisphere symmetric about said longitudinal axis and having an equatorial plane in which said lateral axis extends.

2. A lighting device according to claim 1, wherein said at least one light source comprises at least one light emitting diode.

3. A lighting device according to claim 1, wherein said at least one light source comprises at least one compact fluorescent lamp.

4. A lighting device according to claim 1, wherein said antenna is fully enclosed by said housing.

5. A lighting device according to claim 1, wherein said antenna is located with respect to said at least one light source so as to have a negligible effect on the light emissive properties of said at least one light source.

6. A lighting device according to claim 1, wherein said housing comprises a socket adapted for connection to a power supply.

7. A lighting device according to claim 6, wherein said hemisphere is directed away from said socket.

8. A lighting device according to claim 1, wherein said housing comprises a heat sink.

9. A lighting device according to claim 8, wherein said antenna is supported by said heat sink.

10. A lighting device according to claim 1, wherein said antenna is supported by a holder of said at least one light source.

11. A lighting device according to claim 1, wherein said antenna is supported by a collimator.

12. A lighting device according to claim 1, wherein said antenna is supported by a printed circuit board.

13. A lighting device according to claim 1, wherein said antenna is supported by a dedicated non-conductive carrier.

14. A lighting device according to claim 1, wherein said antenna is planar.

15. A lighting device according to claim 1, wherein said antenna has three-dimensional geometry.

16. A lighting device according to claim 1, wherein said antenna comprises a single-feed antenna.

17. A lighting device according to claim 1, wherein said antenna is adapted for at least one of wireless control and wireless monitoring of said lighting device.

18. A lighting device according to claim 17, wherein said antenna is adapted for wireless communication with a control module.

19. A lighting device according to claim 17, wherein said antenna is adapted for wireless communication with wireless devices in a wireless network.

20. A lighting device according to claim 4, wherein said antenna is located with respect to said at least one light source so as to have a negligible effect on the light emissive properties of said at least one light source.
